(19) United States
(12) Patent Application Publication
(10) Pub. No.: US 2011/0297201 A1
(43) Pub. Date: Dec. 8, 2011

(54) PIVOT KNUCKLE JOINT AND TENT USING THE SAME

(76) Inventor: Yi-Ming CHEN, Taipei City (TW)

(21) Appl. No.: 12/793,155

(22) Filed: Jun. 3, 2010

(51) Int. Cl. F16C 11/04; E04H 15/48

(52) U.S. Cl. 135/144; 403/113

(57) ABSTRACT

A pivot knuckle joint and a tent using the same are provided. The pivot knuckle joint includes a male joint and a female joint. A junction portion for being joined with a support tube is disposed at one end of the male joint and a pivot plate is disposed at the other end of the male joint. A shaft hole is opened on the pivot plate. A junction portion for being joined with a support tube is disposed at one end of the female joint and a first shaft disk and a second shaft disk are disposed at the other end of the female joint. A shaft hole is opened on the first and second shaft disks respectively. An accommodation space is formed at an inner side of the first and second shaft disks. When the pivot plate of the male joint is inserted into the accommodation space, a shaft rod penetrates through shaft holes of the male and female joints, so as to control a positioning status of the male and female joints, thereby unfolding or folding the tent rapidly.

### FIELD OF THE INVENTION

The present invention relates to a tent, and more particularly to a tent capable of being unfolded or folded rapidly by using pivot knuckle joints.

### DESCRIPTION OF THE PRIOR ART

As people have paid more and more attention to leisure life outdoors, camping becomes a popular activity to enjoy the nature. A tent is an indispensable outfit for the camping activity, which provides a temporary shelter. The commercially available tents, especially light and portable ones that can be easily set up or disassembled are very popular among users.

In a conventional mode of setting up a tent, a plurality of support tubes penetrates into sleeve tubes on the tent cloth, and then is inserted into pedestals at a periphery of the tent, so that the support tubes are secured. In another common mode of setting up a tent, a plurality of single-section support tubes is assembled into long rods to support the tent cloth, and the long rods and the tent cloth are secured onto the ground by using camping ropes and rope nails. However, the above set-up and disassembly steps in the modes of setting up the tent are complicated, the set-up or disassembly process is time-consuming and labor-consuming, or even many people are needed to work together at the same time. What's worse, the tent may often collapse as the camping ropes become loosened, thereby causing inconveniences in use.

In view of the above, in order to eliminate the above defects, pivot knuckle joints are used to be unfolded to secure support tubes connected to the pivot knuckle joints at a predetermined clamping angle and to fold the support tubes rapidly by pushing a pressing member, so as to increase conveniences in the set-up and disassembly processes of the tent. The inventor invents the present invention based on experiences for many years through ongoing development and improvement.

### SUMMARY OF THE INVENTION

The primary object of the present invention is to provide a pivot knuckle joint, which is applicable to unfold support tubes connected to male and female joints to a predetermined clamping angle by controlling positioning of the male and female joints using a shaft rod, so as to present a secured status, and applicable to release the secured status of the support tubes by pushing and pressing the shaft rod, so as to fold the support tubes rapidly.

Another object of the present invention is to provide a pivot knuckle joint, wherein male and female joints are connected to a support tube of a tent respectively. When the support tubes are unfolded, a stopper portion of a shaft rod is inserted into the male and female joints to secure an unfolded status of the support tubes. When the support tubes are folded, a pressing member is pressed to enable the stopper portion of the shaft rod to slide out of the male and female joints, so as to rotate the male and female joints to fold the support tubes. Thus, the tent is set up or folded rapidly.

Another object of the present invention is to provide a pivot knuckle joint, wherein male and female joints are connected to a support tube of a tent respectively. A catch slot is formed at a periphery of a shaft hole of a pivot plate of the male joint on a surface opposite to a first shaft disk, and a sliding slot corresponding to the catch slot is provided at a periphery of a shaft hole of the first shaft disk of the female joint. When the male and female joints are unfolded to a predetermined angle, the support tubes are secured at a predetermined clamping angle by inserting a stopper portion of a shaft rod into the male and female joints.

In order to achieve the aforementioned object, the raised access floor unit according to the present invention comprises a frame member and a block member, the frame member has a receiving space for raw materials of the block member to be poured and harden inside the receiving space, characterized in that the bottom of the frame member is disposed with a plurality of T-shaped plate members, wherein the plurality of T-shaped plate members are formed directly from the bottom of the frame member so as to dispose the plurality of T-shaped plate members into the block member while the raw materials of the block member are poured to the frame member, thereby allowing the block member to be incorporated into the frame member securely.

In practice, a catch slot is formed at a periphery of the shaft hole of the pivot plate on a surface of the pivot plate opposite to the first shaft disk. A sliding slot is provided at a periphery of the shaft hole of the first shaft disk. A stopper portion is protruded at one end of the shaft rod. When the shaft rod penetrates through the shaft holes of the male and female joints, the stopper portion is inserted into the sliding slot and the catch slot. The other end of the shaft rod is joined with a pressing member disposed at an outer side of the second shaft disk. An elastic member is disposed between the pressing member and the second shaft disk. Two ends of the elastic member bear against the pressing member and the second shaft disk respectively, and when the pressing member is supported by the elastic member, the shaft rod is secured inside the shaft holes to limit the relative rotation of the male and female joints. When the pressing member is pressed, the stopper portion of the shaft rod is pushed to slide out of the catch slot and the sliding slot, so that the male and female joints can rotate relative to each other, thereby folding or unfolding the support tubes joined with the male and female joints.

Other objects, advantages and novel features of the present invention will become more apparent from the following detailed description when taken in conjunction with the accompanying drawings.

### BRIEF DESCRIPTION OF THE DRAWINGS

FIG. 1 is a schematic assembly view of a pivot knuckle joint according to an embodiment of the present invention

FIG. 2 is a perspective view of the embodiment in FIG. 1.

FIG. 3 is a schematic partial sectional view of the embodiment in FIG. 1 when a stopper portion of a shaft rod is inserted into a catch slot and a sliding slot of male and female joints.

FIG. 4 is a schematic partial sectional view of the embodiment in FIG. 1 when the stopper portion of the shaft rod slides out of the catch slot of the male joint.

FIG. 5 is a perspective view of the embodiment in FIG. 1 in a folded status.

FIG. 6A is a side view of the embodiment in FIG. 1 in an unfolded status.

FIG. 6B is a side view of the embodiment in FIG. 1 in a folded status

FIG. 7 is a perspective view of a tent according to an embodiment of the present invention.

FIG. 8 is a perspective view of a top central pivot disk and a rotating shaft member in the embodiment in FIG. 7.

FIGS. 9 to 12 are schematic views of motions when a support bar is unfolded in the embodiment in FIG. 7.

FIG. 13 is a perspective view of a tent according to another embodiment of the present invention before being unfolded.

FIG. 14 is a perspective view of a tent according to another embodiment of the present invention after being unfolded.

FIG. 15 is a perspective view of a tent according to another embodiment of the present invention.

FIG. 16A is a perspective view of a pivot knuckle joint according to a second embodiment of the present invention when being joined with support tubes.

FIG. 16B is a perspective view of a pivot knuckle joint according to a third embodiment of the present invention when being joined with support tubes.

### DETAILED DESCRIPTION

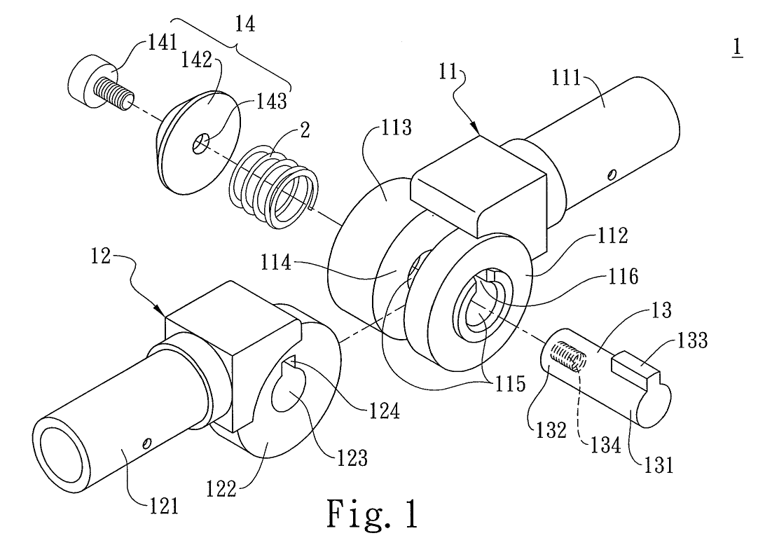

FIG. 1 shows a pivot knuckle joint 1 according to a first embodiment of the present invention. The pivot knuckle joint 1 includes a female joint 11, a male joint 12, a shaft rod 13, and a pressing member 14.

A junction portion 111 for being joined with a support tube of a tent is disposed at one end of the female joint 11, and a first shaft disk 112 and a second shaft disk 113 having a round shape are disposed at the other end of the female joint 11, so that an accommodation space 114 is formed at an inner side of the first and second shaft disks (112 and 113) of the female joint. A shaft hole 115 is opened at a center of the first and second shaft disks (112 and 113) respectively, and a sliding slot 116 is provided at a periphery of the shaft hole 115 of the first shaft disk 112. Moreover, an accommodation slot 117 is provided at an outer side of the second shaft disk 113 (as shown in FIG. 3).

A junction portion 121 for being joined with a support tube of a tent is disposed at one end of the male joint 12, and a pivot plate 122 having a round shape is disposed at the other end of the male joint 12. The pivot plate 122 can be inserted into the accommodation space 114 of the female joint 11. A shaft hole 123 is opened at a center of the pivot plate 122. A catch slot 124 is provided at a periphery of the shaft hole 123 on a surface of the pivot plate 122 opposite to the first shaft disk 112.

The shaft rod 13 has a first end 131 and a second end 132. A stopper portion 133 is protruded at a position of the first end 131 on a side surface of the shaft rod 13. When the pivot plate 122 of the male joint 12 is inserted into the accommodation space 114 of the female joint 11, the first end of the shaft rod 13 penetrates through the female joint 11 and the male joint 12 via the shaft holes (115,123) of the first shaft disk 112, the pivot plate 122, and the second shaft disk 113 in sequence, and the stopper portion 133 is inserted into the sliding slot 116 of the first shaft disk 112, so that the male joint 12 is pivotally disposed on the female joint 11 in a rotatable mode. Moreover, a nut hole 134 is opened inside the second end 132 of the shaft rod 13.

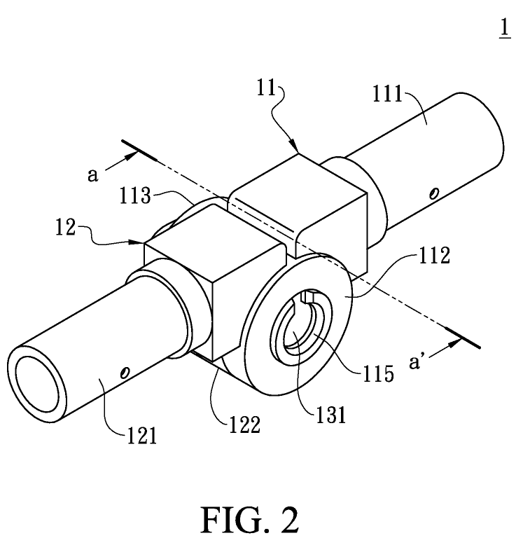

Referring to FIGS. 1 to 3, the pressing member 14 is disposed at an outer side of the second shaft disk 113, which includes a screw 141 and a pad 142. A through hole 143 is opened at a center of the pad 142, and an elastic member 2 in a spring form is disposed between the pad 142 and the second shaft disk 113. Two ends of the elastic member 2 bear against the pad 142 of the pressing member 14 and a bottom of the accommodation slot 117 of the second shaft disk 113 respectively. Therefore, the screw 141 may pass through the through hole 143 and a center of the elastic member 2 and be screwed inside the nut hole 134 of the shaft rod 13. The elastic member 2 is compressed through the pad 142, so that the compressed elastic member 2 provides a restoring force to pull the shaft rod 13 to move towards the outer side direction of the second shaft disk 113, so as to unfold the male and female joints (12 and 11) to a predetermined clamping angle through rotation. In addition, when the sliding slot 116 on the first shaft disk 112 is rotated to a position aligned with the catch slot 124 of the pivot plate 112, the stopper portion 133 of the shaft rod 13 is drawn by the elastic member 2 to slide from the sliding slot 116 of the first shaft disk 112 into the catch slot 124 of the pivot plate 122, so as to secure the shaft rod 13 inside the shaft holes (115 and 123). In addition, the relative rotation of the male and female joints (12 and 11) is limited by the stopper portion 133, so as to fix an unfolded angle between the male and female joints (12 and 11).

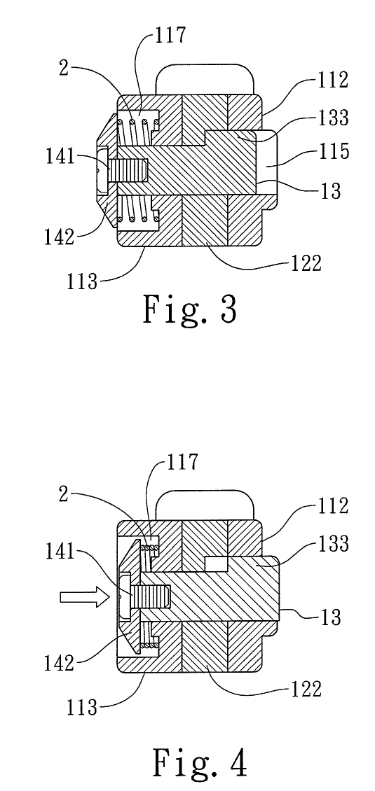

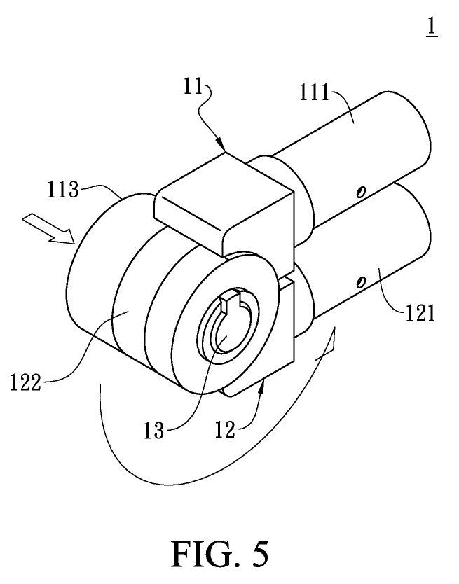

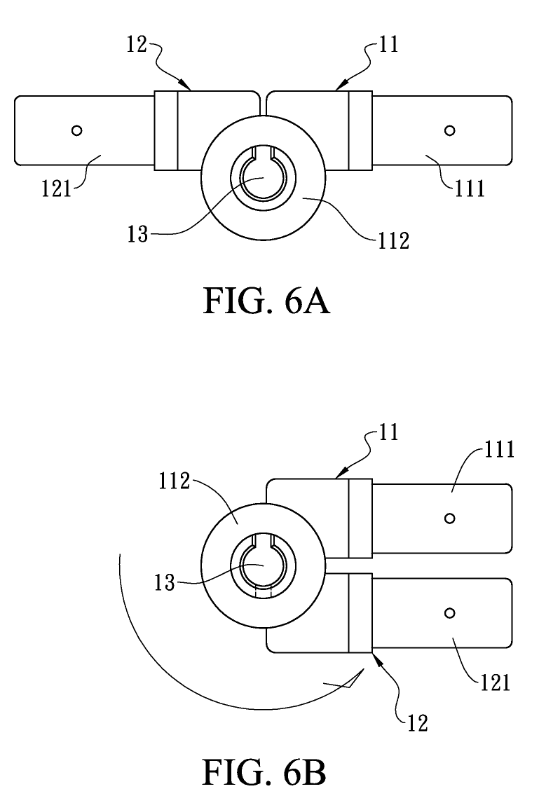

Referring to FIGS. 4 to 6B, during implementation, the stopper portion 133 of the shaft rod 13 is pushed to slide out of the catch slot 124 of the pivot plate 122 by pressing the pressing member 14, so as to rotate and fold the male and female joints (12 and 11).

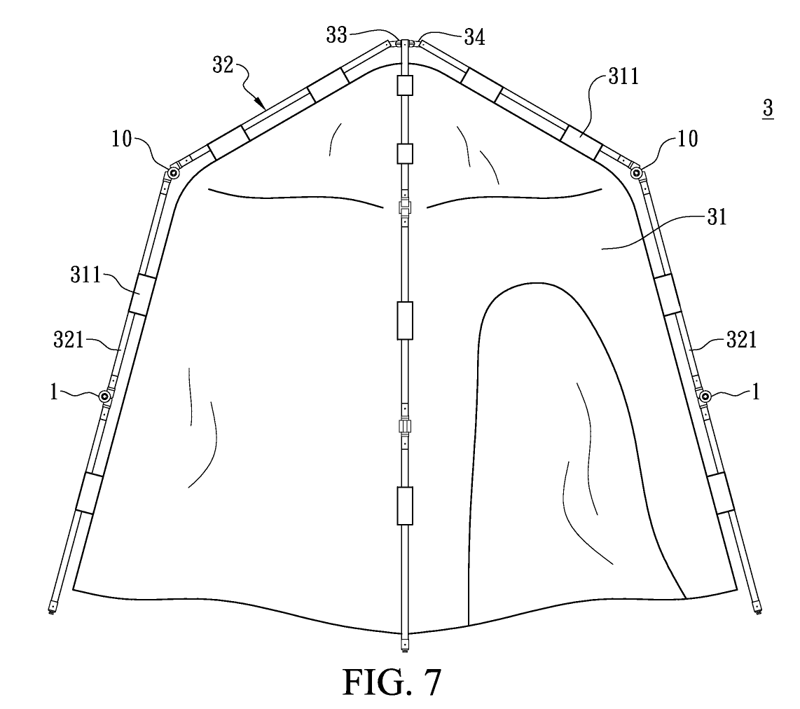

FIG. 7 shows a tent 3 using the pivot knuckle joints 1 according to an embodiment of the present invention. The tent 3 includes a tent cloth 31, a plurality of support bars 32, a plurality of pivot knuckle joints 1, a top central pivot disk 33, and a plurality of rotating shaft members 34. The tent cloth 31 is connected with the support bars 32 through the disposed belts 311.

Each of the support bars 32 is formed by pivotally connecting three single-section support tubes 321 together with two pivot knuckle joints (1 and 10) respectively. After the pivot knuckle joints (1 and 10) are unfolded, the clamping angle of the male and female joints varies depending upon the external appearance of the tent 3. Each of the support bars 32 may also be a single tube or formed by joining a plurality of single-section tubes together. Additionally, each of the support tubes 321 may also be a single tube or formed by joining a plurality of single-section tubes together.

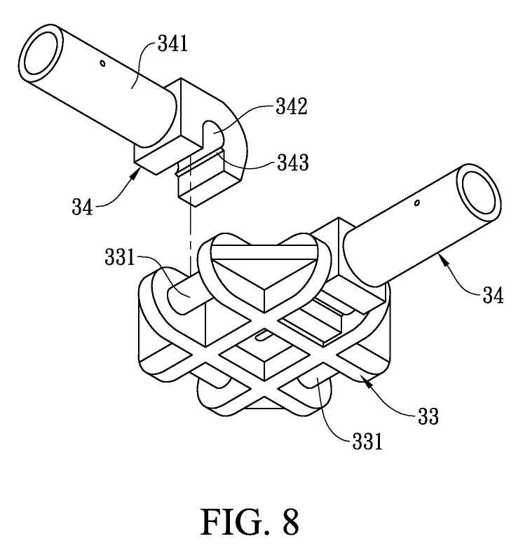

Referring to FIG. 8, a plurality of pivotal rods 331 is disposed at a peripheral of the top central pivot disk 33 respectively. An end 341 of the rotating shaft member 34 is provided for being connected to the support tube 321 as an uppermost section in the support bar 32, and a buckling portion 342 for being pivotally connected to the pivotal rod 331 in a movable mode is disposed at a front end of the rotating shaft member 34. A bump 343 is disposed at an inner side of the buckling portion 342, so as to limit the pivotal rod 331 of the top central pivot disk 33 inside the buckling portion 342, so that the rotating shaft member 34 and the support bar 32 connected to the rotating shaft member 34 can rotate relative to the top central pivot disk 33.

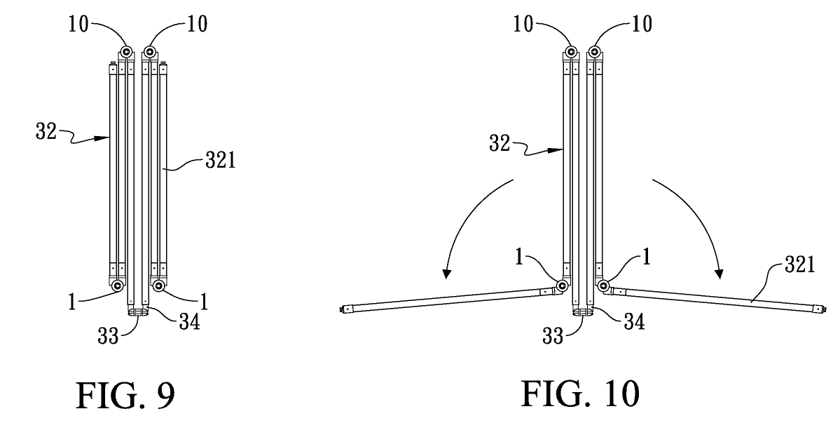

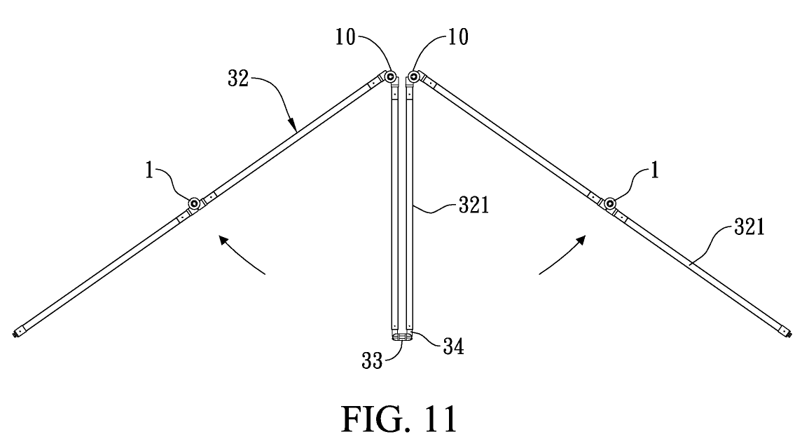

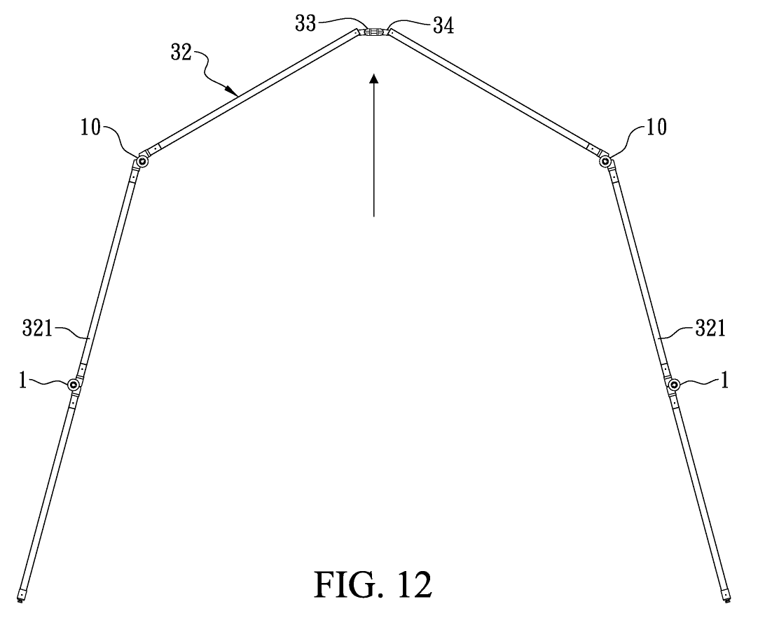

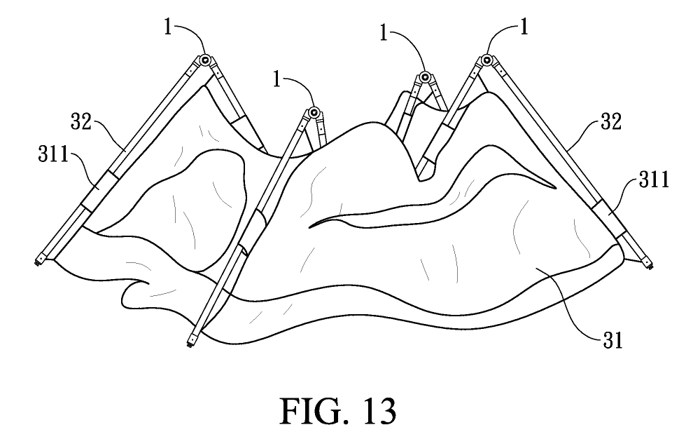

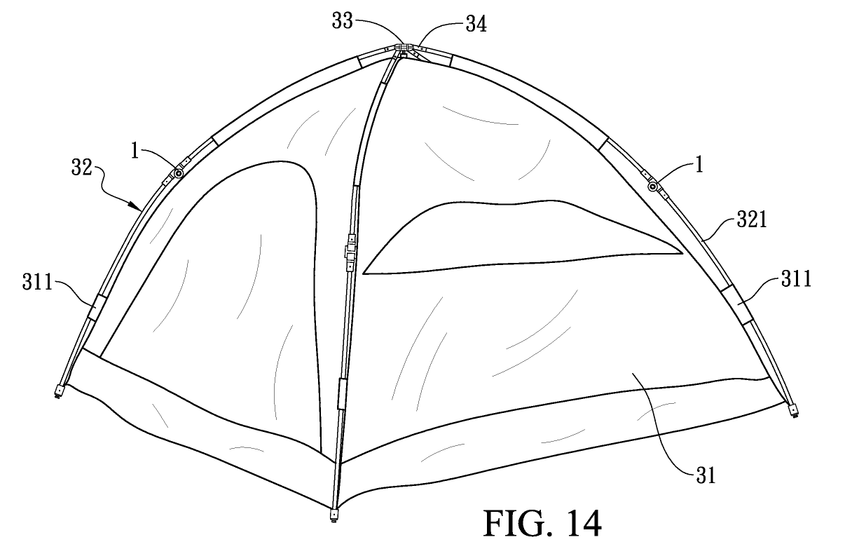

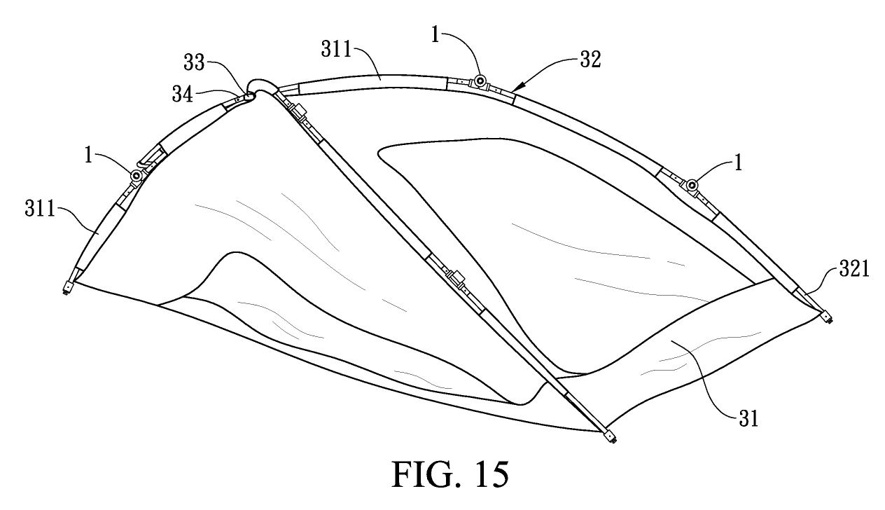

During implementation, FIGS. 9 to 12 are three-dimensional outside views of the support bar 32 of the tent 3 according to the present invention. When the tent 3 is unfolded, the support tube 321 as a lowermost section in the support bar 32 is first unfolded, and the support tube 321 is secured at an unfolded status through the pivot knuckle joint 1. Next, the top central pivot disk 33 is pushed upwards, and the support tubes 321 acting as the uppermost section and the middle section are secured through the other pivot knuckle joint 10, thereby further securing a structure of the tent 3. Referring to FIGS. 13 to 15, the pivot knuckle joints 1 may also be used in the tent 3 having various different forms, so that the tent is enabled to be unfolded or folded rapidly.

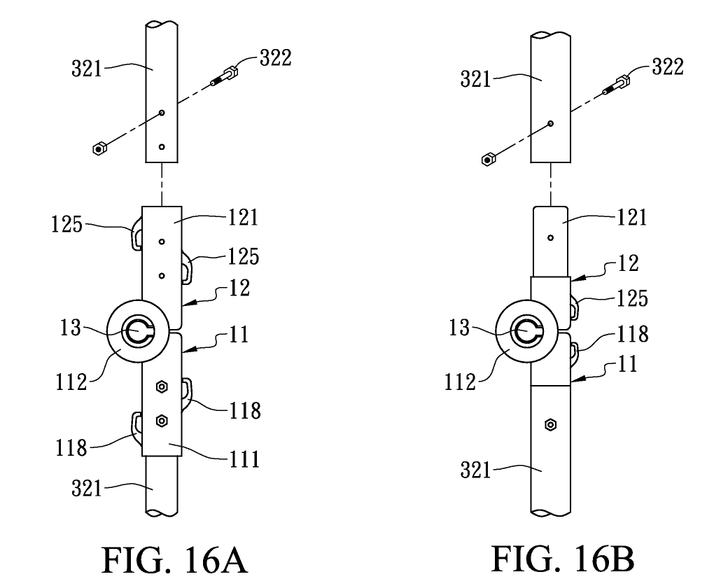

FIG. 16A shows a pivot knuckle joint according to another embodiment of the present invention, which is based on the structure in the first embodiment. The support tubes 321 of the tent are inserted into the junction portions (111 and 121) of the male and female joints (11 and 12) and the joined status of the support tubes is secured through a bolt 322 respectively. A plurality of hook portions (118 and 125) is disposed on a side surface of the junction portions (111 and 121) respectively, so that the snap rings or buckles disposed on the tent cloth of the tent are hooked to the hook portions (118 and 125), so as to secure a shape of the tent cloth rapidly (not shown). The hook portions (118 and 125) may be disposed at other positions of the male and female joints according to the practical joining status of the male and female joints (11 and 12) and the support tubes 321. As shown in FIG. 16B, the junction portions (111 and 121) are fixedly inserted into a support tube 321 respectively. The hook portions (118 and 125) are respectively disposed at one end of the male joint 11 close to the pivot plate and one end of the female joint 12 close to the first and second shaft disks, so as to fix a shape obtained after the tent cloth is unfolded.

Therefore, as for the pivot knuckle joint of the present invention, the support tubes of the tent connected to the pivot knuckle joint are secured in an unfolded status at different clamping angles by changing the positions of the catch slot and the sliding slot on the male and female joints, and the support tubes of the tent can be folded rapidly by pressing the pressing member with one hand, so that the pivot knuckle joint has a simple structure, is convenient for operation and fabrication, and has a higher practicability.

To sum up, according to the contents disclosed above, the present invention can surely achieve the anticipated objects of the present invention. A pivot knuckle joint that can unfold and secure support tubes connected to the pivot knuckle joint at a predetermined clamping angle and fold the support tubes rapidly by pressing the pressing member is provided, so as to enhance the convenience of the tent using the pivot knuckle joint.

It should be understood that different modifications and variations could be made from the disclosures of the present invention by the people familiar in the art without departing the spirit of the present invention.

1. A pivot knuckle joint, applicable to be joined with support tubes of a tent, the pivot knuckle joint comprising:
a male joint, having a junction portion for being joined with a support tube disposed at one end thereof and having a pivot plate disposed at the other end thereof, wherein a shaft hole is opened in the pivot plate; and
a female joint, having a junction portion for being joined with a support tube disposed at one end thereof and having a first shaft disk and a second shaft disk disposed at the other end thereof, wherein a shaft hole is opened on the first and second shaft disks respectively, and an accommodation space is formed at an inner side of the first and second shaft disks, and when the pivot plate of the male joint is inserted into the accommodation space, a shaft rod penetrates through the shaft holes of the male and female joints, so that the male joint is pivotally disposed on the female joint in a rotatable mode;
wherein a catch slot is formed at and recessed from a periphery of the shaft hole of the pivot plate on a surface of the pivot plate opposite to the first shaft disk, and a sliding slot is provided at a periphery of the shaft hole of the first shaft disk;
a stopper portion is formed at one end of the shaft rod and protruded from a periphery of the shaft rod, and when the shaft rod penetrates through the shaft holes of the male and female joints, the stopper portion is inserted into the sliding slot and the catch slot, the other end of the shaft rod is joined with a pressing member disposed at an outer side of the second shaft disk, an elastic member is disposed between the pressing member and the second shaft disk, two ends of the elastic member bear against the pressing member and the second shaft disk respectively, and the shaft rod is secured inside the shaft holes to limit relative rotation of the male and female joints when the pressing member is supported by the elastic member, and the stopper portion of the shaft rod is pushed to slide out of the catch slot when the pressing member is pressed, so that the male and female joints rotate relative to each other, thereby folding or unfolding support tubes joined with the male and female joints.

2. The pivot knuckle joint according to claim 1, wherein an accommodation slot is provided at an outer side of the second shaft disk to accommodate the elastic member therein.

3. The pivot knuckle joint according to claim 1, wherein the pressing member comprises a screw and a pad, the screw penetrates through the pad and is secured on a screw the shaft rod, and the pad is used for pressing against the elastic member.

4. The pivot knuckle joint according to claim 1, wherein a plurality of hook portions is further disposed on the male joint.

5. The pivot knuckle joint according to claim 1, wherein a plurality of hook portions is further disposed on the female joint.

6. A tent, comprising:
a plurality of support tubes and a tent cloth;
a plurality of pivot knuckle joints according to claim 1, for being joined with the support tubes; and
at least one top central pivot disk and a plurality of rotating shaft members, wherein a plurality of pivotal rods is disposed on the top central pivot disk, one end of each of the rotating shaft members is connected to one of the support tubes, and a buckling portion for being movably joined with the pivotal rod is disposed at the other end thereof, so that the support tube connected to the rotating shaft member rotates relative to the top central pivot disk.

7. The tent according to claim 6, wherein an accommodation slot is provided at an outer side of a second shaft disk of the pivot knuckle joint to accommodate an elastic member therein.

8. The tent according to claim 6, wherein a pressing member of the pivot knuckle joint comprises a screw and a pad, the screw penetrates through the pad and is secured on the shaft rod, and the pad is used for pressing against the elastic member.

9. The tent according to claim 6, wherein a plurality of hook portions is further disposed on a male joint of the pivot knuckle joint.

10. The tent according to claim 6, wherein a plurality of hook portions is further disposed on a female joint of the pivot knuckle joint.

11. The tent according to claim 6, wherein a bump is further disposed at an inner side of the buckling portion of the rotating shaft member, so as to limit the pivotal rod of the top central pivot disk inside the buckling portion.
